(19) United States
(12) Patent Application Publication
(10) Pub. No.: US 2010/0228579 A1
(43) Pub. Date: Sep. 9, 2010

(54) Method and System for Quantitatively Expressing a Decision in a Multiple Risk Environment

(75) Inventor: James F. Holden, Barrington Hills, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Holden LLC, South Barrington, IL (US)

(21) Appl. No.: 12/397,678

(22) Filed: Mar. 4, 2009

(51) Int. Cl. G06Q 10/00; G06N 5/02

(52) U.S. Cl. 705/7; 706/52

(57) ABSTRACT

Aspects of the invention may include an exemplary system comprising one or more computers and one or more software applications running on the one or more computers, wherein the one or more software applications quantify the decision and the one or more computers may include a user computer or a computer server. The system further comprises one or more electronic databases, connected to the one or more computers, storing different factor values used in quantifying the decision. The one or more software applications may identify each risk factor in the multiple risk environment and determine a value for one or more risk coefficient factors and opportunity coefficient factors. Further, the one or more software applications may calculate a weighted average for risk coefficient factors based on each risk factor, an opportunity cost coefficient based on opportunity coefficient factors, and calculate the decision quantitatively based on the weighted average for risk coefficients and the opportunity cost coefficient.

### FIELD OF THE INVENTION

The invention generally relates to methods and systems for assessing risk and particularly to methods and systems for quantitatively expressing a decision in a multiple risk environment.

### BACKGROUND OF THE INVENTION

A company may encounter different opportunities in different environments. Some opportunities may include investments in different securities, mergers and acquisitions of different companies, and research and development of new products. Each environment may contain several risks. Company personnel may have trouble assessing the risks for the opportunity to make a decision whether to pursue the opportunity in the particular multiple risk environment.

### BRIEF SUMMARY OF THE INVENTION

Aspects of the invention provide for a method and system for quantitatively expressing a decision in a multiple risk environment. An exemplary computer implemented method may comprise the steps of identifying each risk factor in the multiple risk environment, and determining the value for one or more risk coefficient factors for each risk factor and the value for one or more opportunity coefficient factors. A further step may include calculating a weighted average for risk coefficient factors based on the one or more risk coefficient factors, an opportunity cost coefficient based on the one or more opportunity coefficient factors, and the decision based on the weighted average for risk coefficient factors and the opportunity cost coefficient. One or more steps of the exemplary computer implemented method may be implemented using one or more software applications running on a computer wherein the computer may be a user computer or a computer server.

Another exemplary computer implemented method may comprise the steps of determining one or more risk factors, risk coefficient factors, opportunity coefficient factors, and types of decisions. A further step may include determining the one or more values for each risk coefficient factor, each opportunity coefficient factor, and each type of decision. An additional step may be selecting an algorithm that uses each risk coefficient factor, opportunity coefficient factor, to quantitatively express a decision. The steps of the exemplary method may be implemented using one or more software applications running on a computer which may be a user computer or a computer server.

Aspects of the invention may include an exemplary system comprising one or more computers and one or more software applications running on the one or more computers, wherein the one or more software applications quantify the decision and the one or more computers may include a user computer or a computer server. The system further comprises one or more electronic databases, connected to the one or more computers, storing different factor values used in quantifying the decision. The one or more software applications may identify each risk factor in the multiple risk environment and determine a value for one or more risk coefficient factors and opportunity coefficient factors. Further, the one or more software applications may calculate a weighted average for risk coefficient factors based on each risk factor, an opportunity cost coefficient based on opportunity coefficient factors, and calculate the decision quantitatively based on the weighted average for risk coefficients and the opportunity cost coefficient.

### BRIEF DESCRIPTION OF THE SEVERAL VIEWS OF THE DRAWINGS

FIG. 1 is a general architectural overview of an exemplary system for quantitatively expressing a decision in a multiple risk environment, according to an aspect of the invention.

FIGS. 2-4 are flow diagrams of exemplary methods for quantitatively expressing a decision in a multiple risk environment, according to an aspect of the invention.

FIGS. 5-7 are exemplary user interfaces for exemplary software applications that are used in methods and systems for quantitatively expressing a decision in a multiple risk environment, according to an aspect of the invention.

### DETAILED DESCRIPTION OF THE INVENTION

A company may encounter different opportunities in different environments. Some opportunities may include investments in different securities, mergers and acquisitions of different companies, and research and development of new products. Each environment may contain several risks. Company personnel may have trouble assessing the risks for the opportunity to make a decision whether to pursue the opportunity in the particular multiple risk environment.

Aspects of the invention provide a novel approach for determining the appropriate action to pursue when confronted with an opportunity in a multiple risk environment. Further, aspects of the invention quantitatively express a decision of whether to pursue an opportunity in the multiple risk environment. Persons of ordinary skill in the art recognize that aspects of the invention may be used by company personnel to facilitate decision-making in a multiple risk corporate environment. Persons of ordinary skill in the art would further understand that other aspects of the invention may be utilized by individuals to facilitate their decision-making in a multiple risk environment.

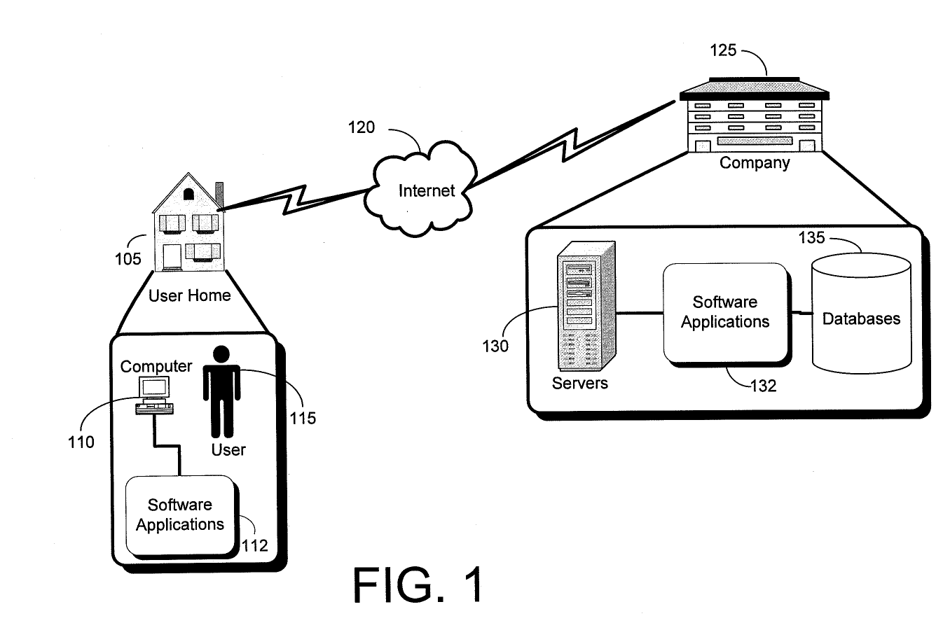

FIG. 1 is a general architectural overview of an exemplary system for quantitatively expressing a decision in a multiple risk environment, according to an aspect of the invention. FIG. 1 shows one or more computer servers 130 running one or more software applications 132 and having access to one or more databases 135 on a company's premises 124. One or more software applications implement aspects of the invention to quantitatively express a decision in a multiple risk environment for a company or individual. FIG. 1 further shows a user 115 interacting with a computer 110 at the user's home 105, the computer 110 running one or more software applications. The one or more software applications running on the user's home computer 110 may access one or more software applications 132 running one or more computer servers 130, or access one or more databases 135 residing on a company's premises 125 across the Internet 120. The one or more software applications 112 running a user's 115 home computer 110 may include a graphical user interface such as a web browser or a spreadsheet program. The one or more software applications 132 running on one or more computer servers 130 may include spreadsheet computer programs, web-based computer programs, and database computer programs. The one or more databases 135 may store information that is accessed by the one or more software applications (112, 132). These databases can be any electronic storage media and can be connected a computer 110 or a computer server 130. This information may include values for factors that are used in quantitatively expressing a decision in a multiple risk environment.

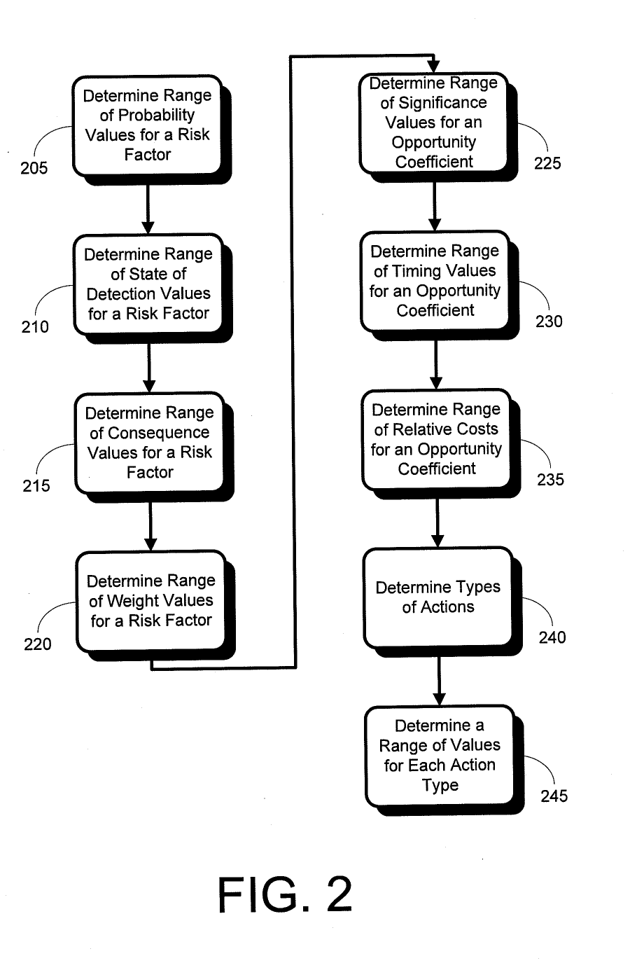

FIG. 2 is a flow diagram of an exemplary method for quantitatively expressing a decision in a multiple risk environment, according to an aspect of the invention. A company or an individual may determine a range of values for each factor that is used in the exemplary method. Factors may include one or more risk coefficient factors, opportunity coefficients, and actions. A risk coefficient factor may be a variable that is used to quantify a risk and may be expressed in terms of a probability value, state of detection of value, consequence value, and a weight value. A probability value expresses the probability or likelihood of occurrence of a particular risk factor. A state of detection value expresses the stage in the opportunity the risk may be detected. Risks that manifest early in the opportunity pursuit may have less of an impact in the decision-making process than risks that are detected later. A consequence value expresses the severity of a consequence if and when it occurs. A risk may have a severe, moderate, or low impact in the decision-making process. A weight value for a risk factor expresses the relative impact of the risk compared to other risks or risk factors in the environment.

An opportunity coefficient may be expressed in terms of one or more opportunity coefficient factors that may include a significance factor value, timing factor value, and a relative cost of pursuit factor value. A significance factor value may quantify the importance of the opportunity. A timing factor value takes into account the timing in pursuing the opportunity. Alternatively, a relative cost of pursuit factor expresses the amount of time, money, resources, etc., that is needed to pursue the opportunity.

An action may be expressed in terms of one or more risk coefficient factors and one or more opportunity coefficients. One or more actions are used to make a decision regarding whether to pursue an opportunity in a multiple risk environment.

Company personnel or an individual may perform the steps of the exemplary method shown in the figures and described in the detailed description herein. The steps of the exemplary method will be described as being performed by company personnel; however, persons of ordinary skill in the art understand that this does not limiting the invention in any way. Steps 205-220 describe steps for determining range of values for a risk coefficient factor and storing each value in the range in one or more electronic databases. At a step 205, company personnel determine a range of Probability values for a risk factor and stores each of value in the range in the one or more databases. Company personnel determine a range of values for a State of Detection factor at a step 210, and stores each of them in the one or more databases. At a step 215, company personnel determine a range of values for a Consequence factor and stores each of them in the one or more databases. Company personnel determine a range of weight values for a risk factor, at a step 220, and stores the range of weight values in the one or more databases.

Steps 225-235 determine value ranges for several factors that express an opportunity coefficient and stores them in one or more databases. At a step 225, company personnel determine the range of Significance values for an opportunity coefficient. The range of Significance values are stored by company personnel in the one or more databases. Timing values are determined by company personnel, at a step 230, and are stored in the one or more databases. At a step 235, company personnel determine the range of values of Relative Cost of Pursuit for an opportunity coefficient and stores each of them in the one or more databases.

At a step 240, company personnel determine the different types of actions to perform in pursuing an opportunity. These types of actions are stored in one or more databases and may include verbal descriptions such as Go, Stop, or Proceed with Caution. At a step 245, company personnel determine a range of values for each action type and store them in one or more databases.

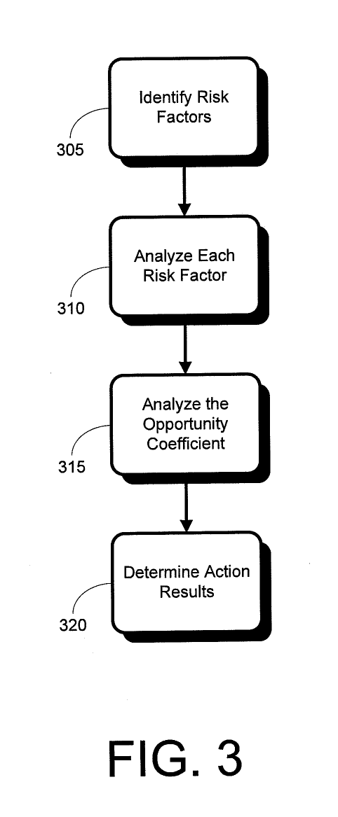

FIG. 3 is another flow diagram of an exemplary method for quantitatively expressing a decision in a multiple risk environment, according to an aspect of the invention. At a step 305, company personnel identify the risks of the environment. Company personnel analyze each risk factor at step 310, in accordance with the detailed description discussed herein. At a step 315, company personnel analyze the Opportunity Coefficient. Using the analysis of each risk factor and the opportunity coefficient, company personnel determine one or more action results, at a step 320.

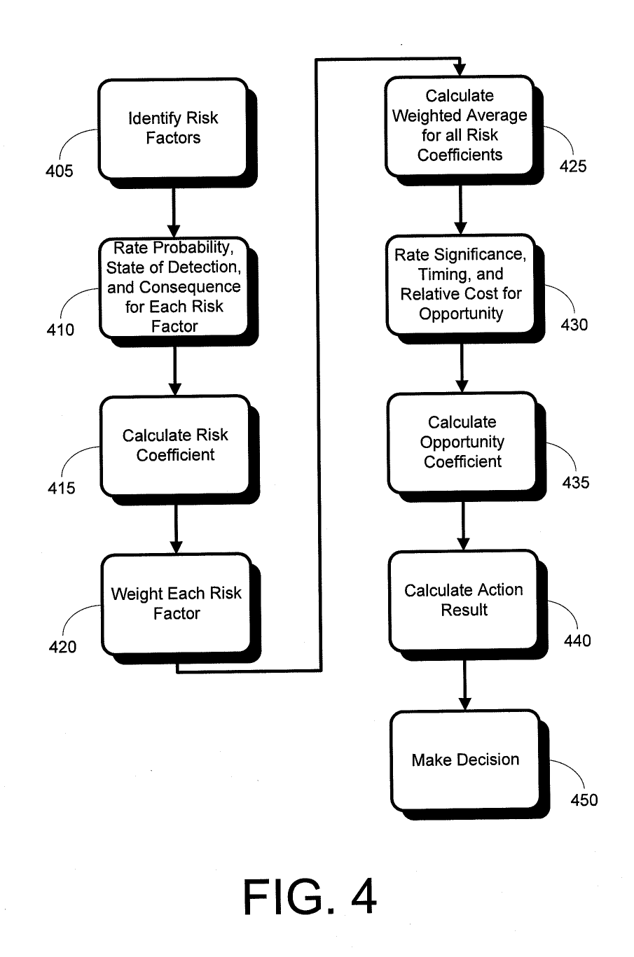

FIG. 4 is another flow diagram of an exemplary method for quantitatively expressing a decision in a multiple risk environment, according to an aspect of the invention. Company personnel identify one or more risk factors associated with pursing an opportunity within a multiple risk environment at a step 405. Using one or more software applications (See FIG. 1), at a step 410, company personnel rate the Probability, State of Detection, and Consequence risk coefficient factor for each risk. Rating involves selecting a value from the range of values for each of a Probability, State of Detection, and Consequence factor, wherein the range of values for each factor is stored in one or more databases. An exemplary software application used in rating factors may be a web-based program, a database program, or a spreadsheet program.

At a step 425, company personnel may calculate a risk coefficient for each risk factor that is expressed in terms of the selected Probability, State of Detection, and Consequence values for the risk factor using a software application. The following is an exemplary algorithm that calculates a risk coefficient for each risk factor.

RCᵢ=((P)(C)/SD)/9

RCᵢ is the risk coefficient for a risk factor i. P, C, and SD are the selected values for the probability, consequence, and state of detection factors for each risk factor, respectively.

At a step 420, company personnel select a weight value for each risk factor from the range of weight values stored in one or more databases using one or more software applications. At a step 425, company personnel may calculate a weighted average for all risk coefficients using a software application. The following is an exemplary algorithm that calculates a weighted average for all risk coefficients.

WA=(WRC₁+WRC₂+ . . . +WRCn)/n

WA is the calculated weighted average for all risk coefficients, WRCᵢ is the weighted risk coefficient which is found by multiplying the risk coefficient by the weight for each risk factor, and n is the total number of risk factors in the environment.

At a step 430, company personnel rate the Significance, Timing, and Relative Cost of Pursuit for an opportunity coefficient. Rating involves selecting a value from the range of values for each of a Significance, Timing, and Relative Cost factor, wherein the range of values for each factor is stored in one or more databases. An exemplary software application used to rate each opportunity coefficient factor may be a web-based program, database program, or spreadsheet program.

At a step 435, company personnel may calculate an opportunity coefficient using the following exemplary algorithm.

OC=(S)(T)/C

OC is the opportunity coefficient, S is the value of the Significance factor, T is the value of the Timing value, and C is the Relative Cost of Pursuit value.

At a step 440, company personnel calculate one or more action results using the following exemplary algorithm.

AR=OC/WA

AR is the action result, OC is the opportunity coefficient, and WA is the weighted average for all risk coefficients. A person of ordinary skill in the art would understand that the algorithms disclosed are exemplary and not limiting in any way.

At step 450, company personnel make a decision whether to pursue the opportunity in the multiple risk environment based on the one or more action results. A priori, company personnel may determine a set of value ranges for an action result. Each value range determines a decision. For example, if an action result is between a value of 1 and 10, company personnel may decide not to pursue the opportunity. Further, if an action result has a value more than 30, then a company may decide to go ahead with the opportunity. However, if the action result has a value between 11 and 30, the company may decide to proceed with caution with the opportunity.

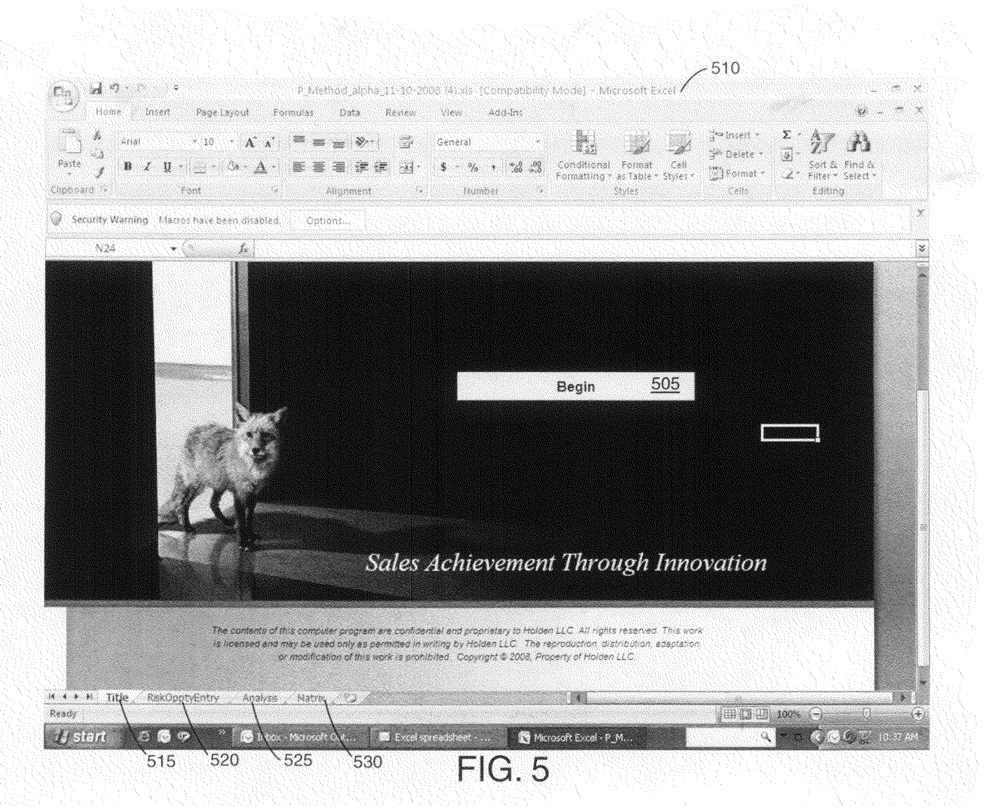

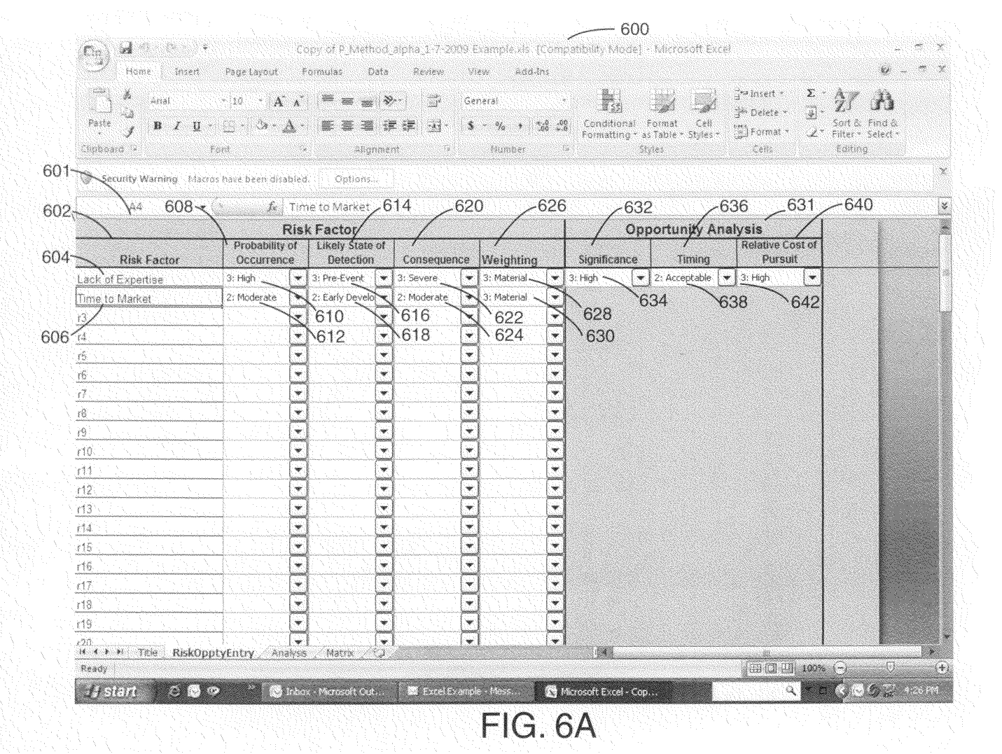

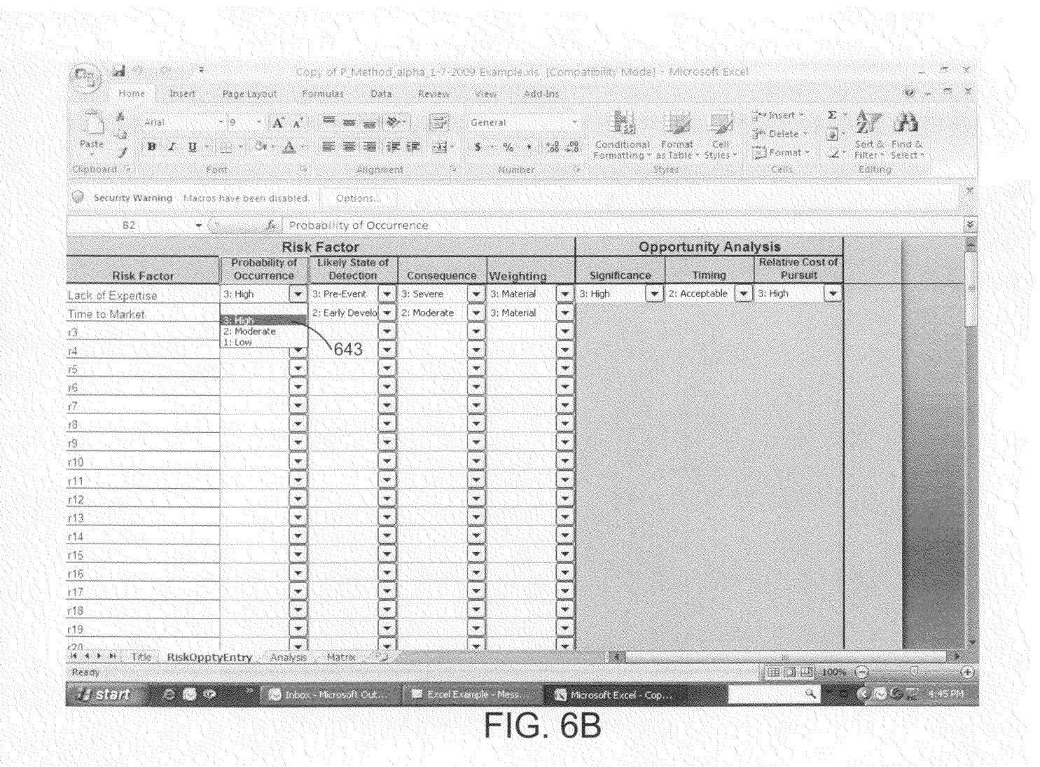

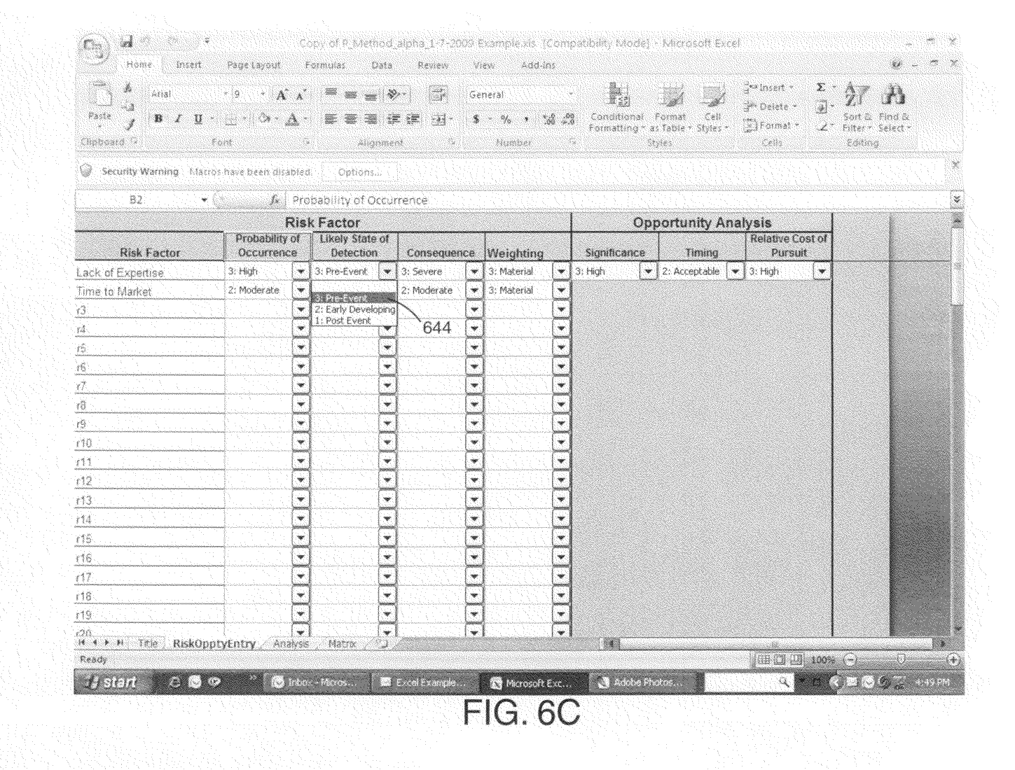

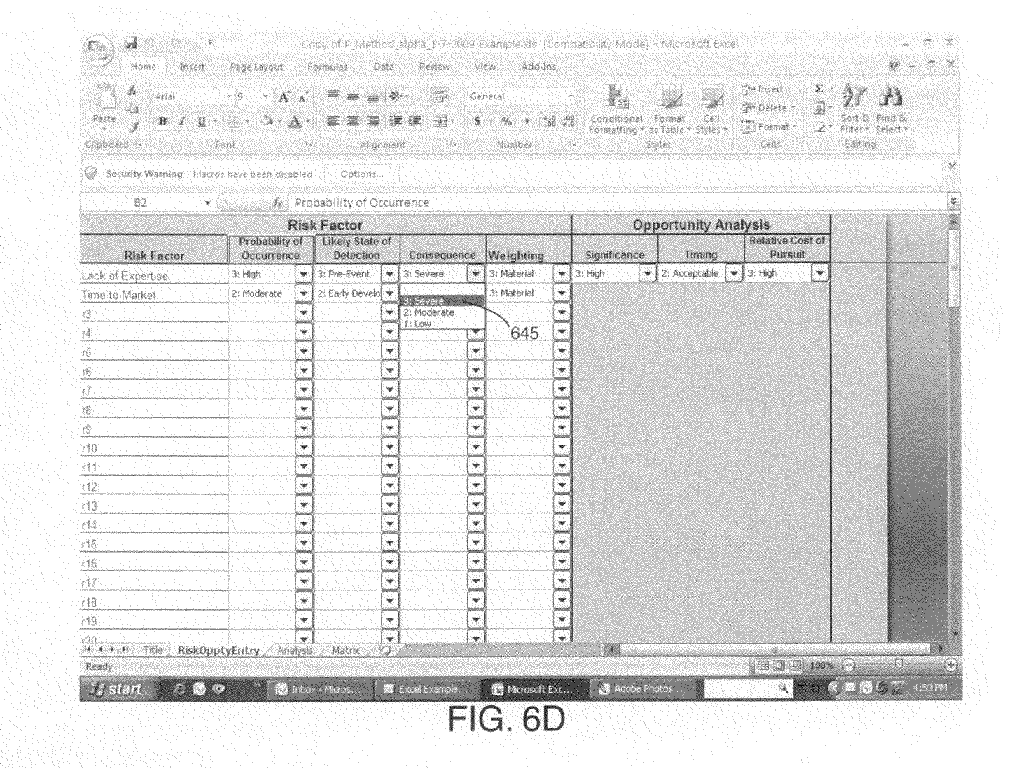

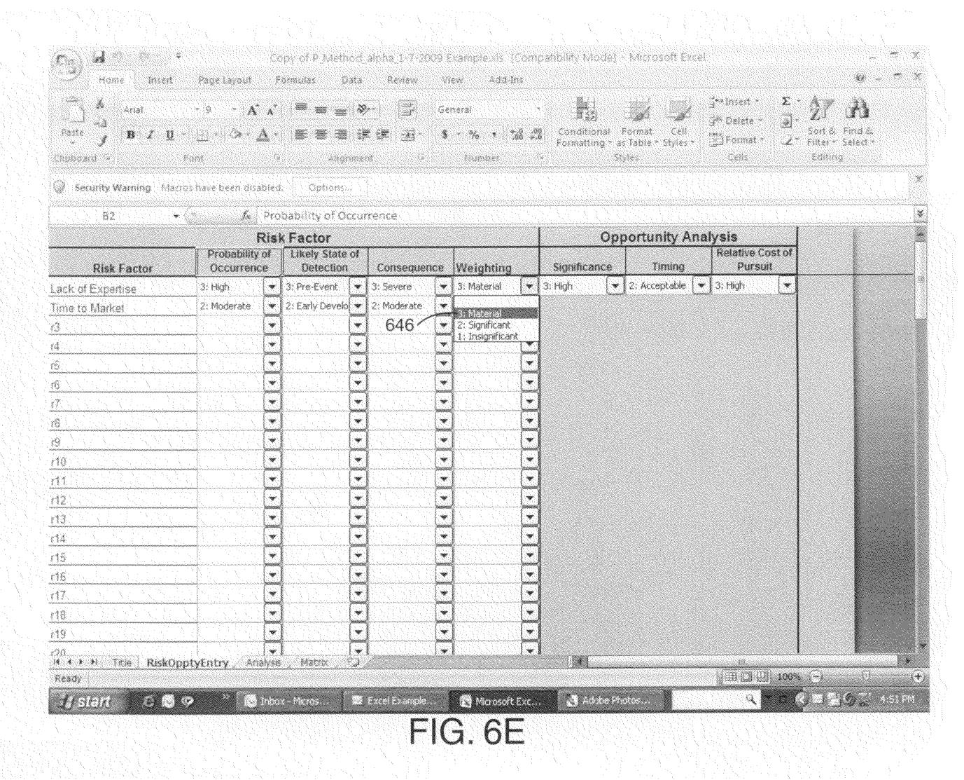

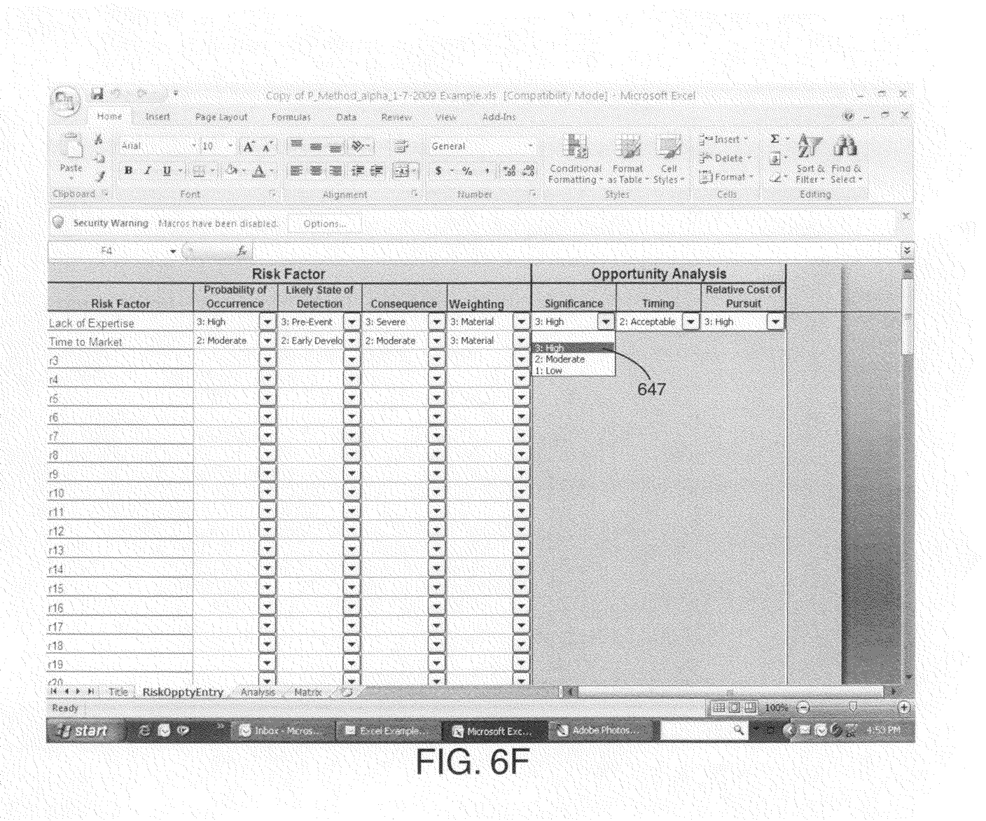

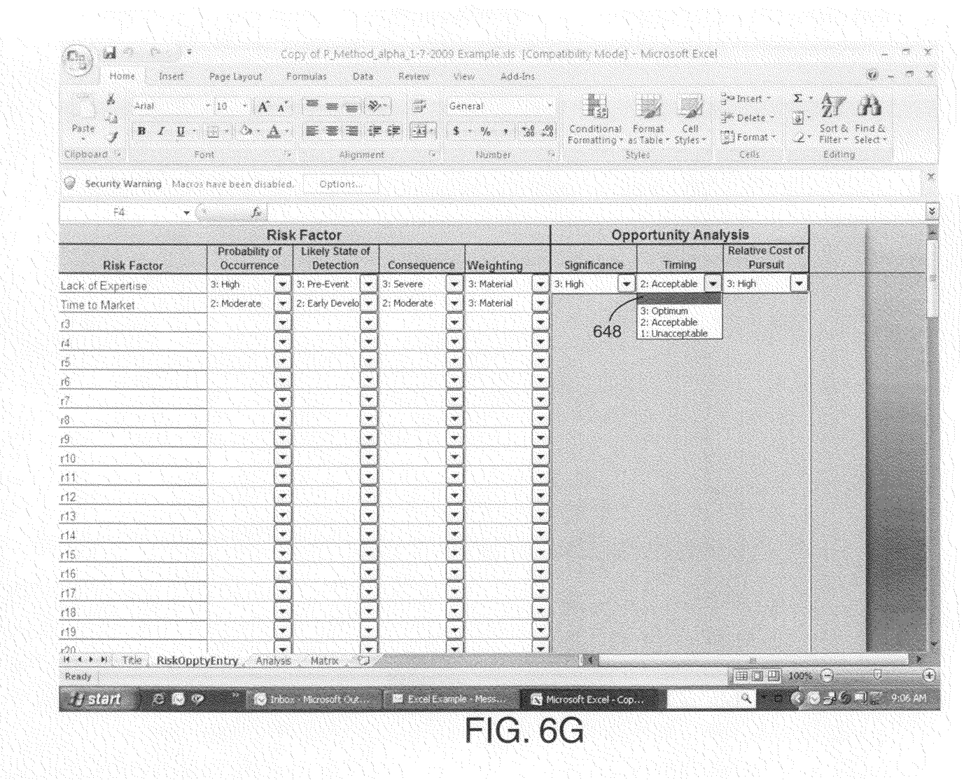

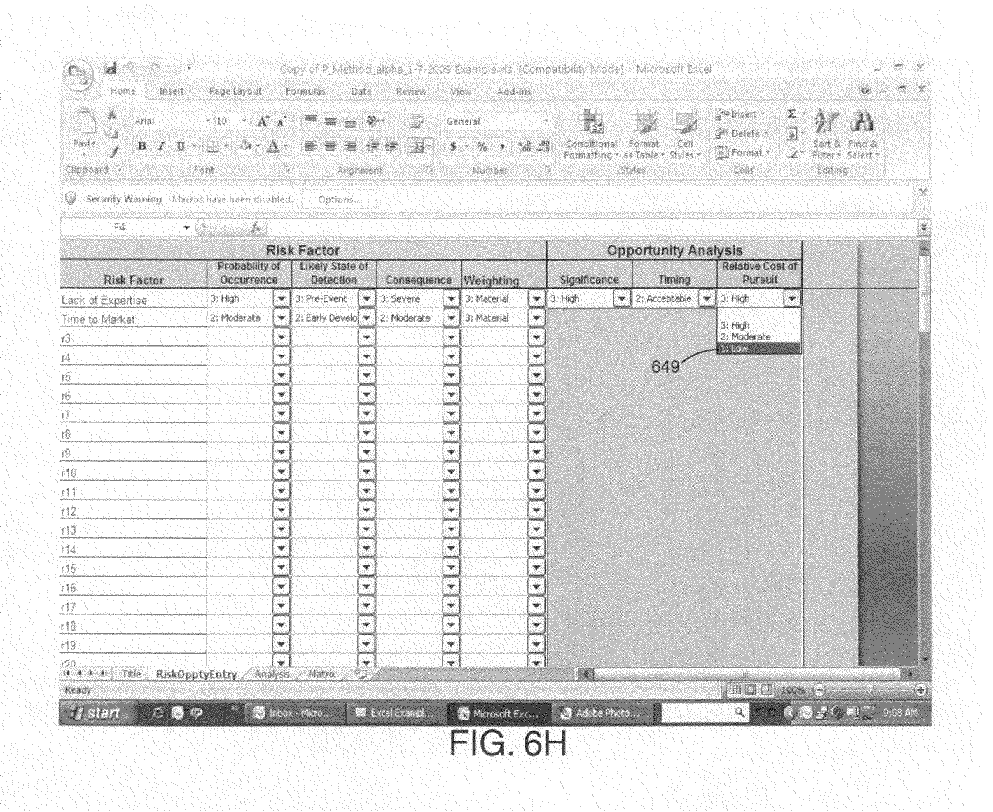

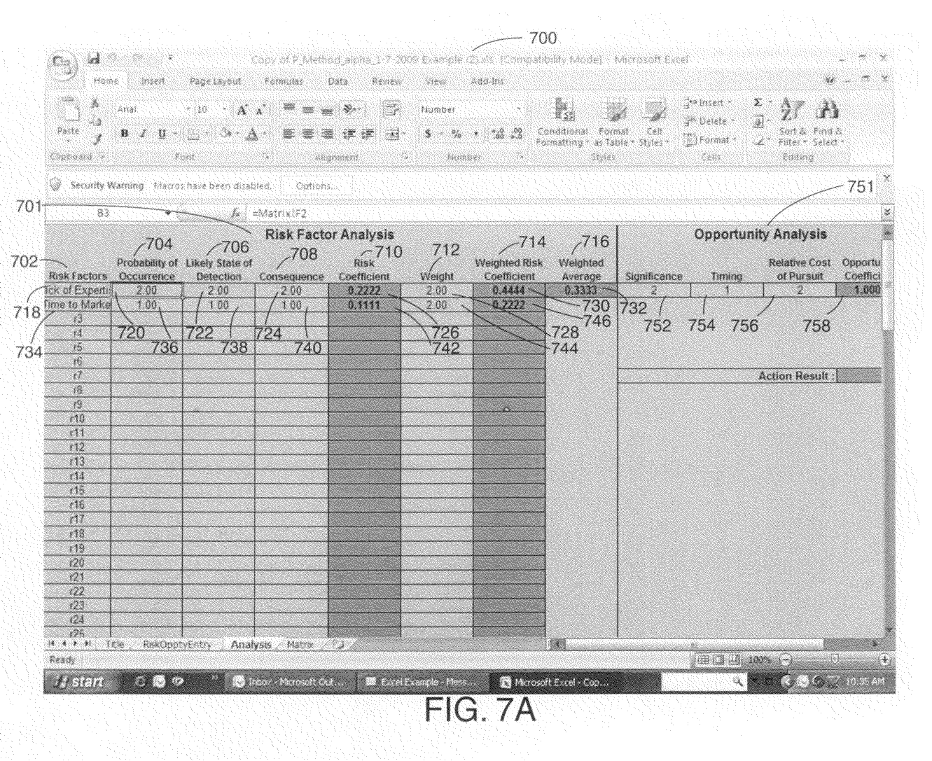

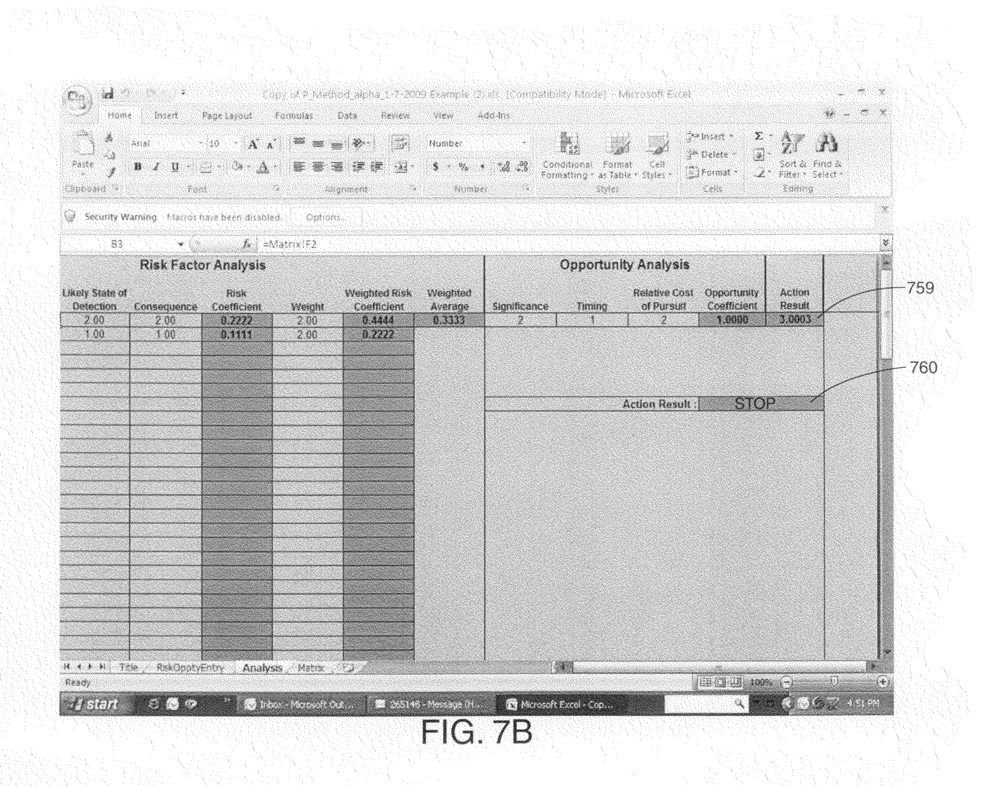

FIGS. 5-7 are exemplary user interfaces for exemplary software applications that are used in methods and systems for quantitatively expressing a decision in a multiple risk environment, according to an aspect of the invention. FIG. 5 is user interface 510 of a spreadsheet program. The spreadsheet program may be enabled with macro functions. A user, which may be company personnel, an individual, or any other type of user, may access other functions of the software application by clicking the Begin pushbutton 505. A user may also access different parts of the spreadsheet program by clicking different tabs including Title 515, Risk Opportunity Entry 520, Analysis 525, and Matrix 530. The Title tab is shown in FIG. 5. Tabs for Risk Opportunity Entry 520 and Analysis 525 are shown in FIGS. 6A-H and FIGS. 7A-7B, respectively.

FIGS. 6A-H disclose a Risk Opportunity Entry tab of a spreadsheet program. A user may enter one or more risk factors in the first column of the spreadsheet program 602. In the examples shown in FIGS. 6A-H, the opportunity may be to research and develop a new product. There may be two risk factors which are Lack of Expertise 604 and Time to Market 606. The factors may be related. For example, a company may need to build its expertise to research and develop a new product, but that may increase the time to market. The spreadsheet program tab can be separated between a Risk Factor section 601 and an Opportunity Analysis section 631. In the Risk Factor section 601, a user may select the value of the Probability of Occurrence 608, Likely State of Detection 614, Consequence 620 and Weighting 626 factors for each risk. In the Opportunity Analysis section 631, a user may select the value of the Significance 632, Timing 636, and Relative Cost of Pursuit 640 factor for the opportunity. In the example shown in FIGS. 6A-H, the range of values for each factor is between 1 and 3. A user may select a value of 3 for each factor Probability of Occurrence, Likely State of Detection, and Consequence for the Lack of Expertise risk factor (610, 616, and 622). A user may select a value of 2 for each factor Probability of Occurrence, Likely State of Detection, and Consequence for the Time to Market risk factor (612, 618, and 624). A user may select a value for the Weighting of each risk factor. In FIG. 6A, a user selected a weight value of 3 for the Lack of Expertise risk factor 628 and a value of 2 for the Time to Market risk factor 630. For the opportunity coefficient factors, a user may select a significance value of 3, a timing value of 2, and a relative cost value of 3 for the opportunity (634, 638, and 642).

FIGS. 6B-H show the same exemplary user interface as shown in FIG. 6A, but in addition, shows the different values a user may select for each factor. Each factor ranges between 1 and 3 in an embodiment of the invention. Each value may have a verbal description associated therewith. In FIG. 6B, the Probability of Occurrence factor has possible values of High (3), Moderate (2), and Low (1) 643. In. FIG. 6C, the Likely State of Detection has possible values of Pre-Event (3), Early Developing (2), and Post Event (1) 644. In FIG. 6D, the Consequence factor has possible values of Severe (3), Moderate (2), and Low (1) 645. In FIG. 6E, the Weighting factor has possible values of Material (3), Significant (2), and Insignificant (1) 646. In FIG. 6F, for the Opportunity Analysis, the Significance factor has values of High (3), Moderate (2), and Low (1) 647. In FIG. 6G, the Timing factor has possible values of Optimum (3), Acceptable (2), and Unacceptable (1) 648. In FIG. 6H, the Relative Cost of Pursuit factor has possible values of High (3), Moderate (2), and Low (1) 649.

FIGS. 7A and 7B show an exemplary user interface of the Analysis tab 700 for a spreadsheet program. The tab may have a Risk Factor Analysis section 701 and an Opportunity Analysis section 751. The spreadsheet program lists each risk factor (718, 734) entered by a user in the Risk Opportunity Entry tab (See FIG. 6) in a first column 702. The spreadsheet program may further list the values of the Probability of Occurrence (704, 720, and 736), Likely State of Detection (706, 722, and 738), and Consequence (708, 724, and 740) factor entered by the user in the Risk Opportunity Entry tab of the spreadsheet program. The spreadsheet program calculates the Risk Coefficient (710, 726, and 742) for each risk factor using an algorithm such as the one described in discussing FIG. 4. In addition, the spreadsheet program lists the Weight value for each risk factor entered by the user in the Risk Opportunity Entry tab (712, 728, and 744). The spreadsheet calculates the Weighted Risk Coefficient using an algorithm such as the one discussed when describing FIG. 4 and lists the Weighted Risk Coefficient in a column in the spreadsheet for each risk factor (714, 730, and 746). Thereafter, the spreadsheet may calculate the Weighted Average for all Risk Coefficients using an algorithm such as the one discussed when describing FIG. 4 and lists it in the spreadsheet 732.

In the Opportunity Analysis section 751 of the spreadsheet program tab, the spreadsheet lists the values for the Significance, Timing and Relative Cost of Pursuit factor of the opportunity entered by the user (752, 754, and 756). Thereafter, the spreadsheet program may calculate the opportunity coefficient and the action result (758 and 759) using one or more algorithms such as the ones discussed when describing FIG. 4. The spreadsheet program may also list a verbal form of the Action Result 760.

Persons of ordinary skill in the art would understand that aspects of the invention may quantify risk in an environment containing many risks (hundreds, thousands, etc.) and each risk may have many factors. Further, aspects of the invention may include many opportunity coefficient factors. A computer implemented method and computer system is significant several in aspects of the invention to efficiently and cost-effective quantify a decision in a multiple risk environment. In addition, aspects of invention transform data relating to risk factors and opportunity coefficients into a quantified action result improving a company or individual in the way in which they make decision.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A computer implemented method for quantitatively expressing a decision in a multiple risk environment, the method comprising the steps of:
(a) determining one or more risk factors, risk coefficient factors, opportunity coefficient factors, and types of decisions;
(b) determining a range of values for each risk coefficient factor, each opportunity coefficient factor, and each type of decision;
(c) selecting an algorithm that uses each risk coefficient factor and each opportunity coefficient factor, to quantitatively express a decision; and
wherein the steps (a)-(c) are implemented using one or more software applications running on one or more computers.

2. The computer implemented method according to claim 1, wherein the risk coefficient factors are selected from the group consisting of a probability factor, state of detection factor, and a consequence factor.

3. The computer implemented method according to claim 1, wherein the opportunity coefficient factors are selected from the group consisting of a significance factor, timing factor, and a relative cost of pursuit factor.

4. The computer implemented method according to claim 1, wherein the types of decision are selected from the group consisting of go, stop, and proceed with caution.

5. The computer implemented method according to claim 1, the method further comprising the step of storing each risk coefficient factor, each opportunity coefficient factor, each type of decision, and each value in the range of values for each risk coefficient factor, each opportunity coefficient factor, and each type of decision in an electronic database wherein the electronic database is connected to the one or more computers.

6. The computer implemented method according to claim 1, wherein one or more software applications are selected from the group consisting of web-based programs, spreadsheet programs, and database programs.

7. A computer implemented method for quantitatively expressing a decision in a multiple risk environment, the method comprising the steps of:
(a) identifying each risk factor in the multiple risk environment;
(b) determining the value for one or more risk coefficient factors for each risk factor and the value for one or more opportunity coefficient factors;
(c) calculating (i) a weighted average for risk coefficient factors based on the one or more risk coefficient factors, (ii) an opportunity cost coefficient based on the one or more opportunity coefficient factors, and (iii) the decision based on the weighted average for risk coefficient factors and the opportunity cost coefficient; and
wherein the steps (a)-(c) are implemented using one or more software applications running on one or more computers.

8 The computer implemented method according to claim 7, wherein the risk coefficient factors are selected from the group consisting of a probability factor, state of detection factor, and a consequence factor.

9. The computer implemented method according to claim 7, wherein the opportunity coefficient factors are selected from the group consisting of a significance factor, timing factor, and a relative cost of pursuit factor.

10. The computer implemented method according to claim 7, the method further comprising the steps of:
(d) selecting a probability factor value, a state of detection factor value, and a consequence factor value for each risk factor;
(e) calculating a risk coefficient for each risk factor by multiplying the probability value with the likely state of detection value, dividing by the consequence value and a scaling factor; and
wherein the steps (d)-(e) are implemented using the one or more software applications running on the one or more computers.

11. The computer implemented method according to claim 7, the method further comprising the steps of:
(f) selecting a weight factor value for each risk factor;
(g) calculating a weighted risk coefficient for each risk factor by multiplying the risk coefficient for each risk factor by the weight factor value for each risk factor;
(h) calculating the weighted average for risk coefficients by summing the weighted risk coefficient for each risk factor and then dividing by the number of risk factors; and
wherein the steps (f)-(h) are implemented using the one or more software applications running on the one or more computers.

12. The computer implemented method according to claim 7, the method further comprising the step of selecting a significance factor value, a timing factor value, and a relative cost of pursuit factor value of the opportunity within the multiple risk environment using one or more software applications running on the one or more computers.

13. The computer implemented method according to claim 7, the method further comprising the step of calculating an opportunity coefficient by multiplying the significant value by the timing value and dividing by the relative cost of pursuit value using the one or more software applications running on the one or more computers.

14. The computer implemented method according to claim 7, the method further comprising the step of calculating the decision quantitatively by dividing the opportunity coefficient by the weighted average for risk coefficients using the one or more software applications running on the one or more computers.

15. The computer implemented method according to claim 7, the method further comprising the step of presenting an electronic user interface on the one or more computers using the one or more software applications.

16. The computer implemented method according to claim 7, the method further comprising the step of accessing the value for each risk coefficient factor and each opportunity coefficient factor from an electronic database wherein the electronic database is connected to the one or more computers.

17. The computer implemented method according to claim 7, wherein one or more software applications are selected from the group consisting of web-based programs, spreadsheet programs, and database programs.

18. A computer system that quantitatively expresses a decision in a multiple risk environment, the system comprising:
one or more computers;
one or more software applications running on the one or more computers, wherein the one or more software applications quantify the decision;
one or more electronic databases storing different factor values used in quantifying the decision; and
wherein the one or more software applications identify each risk factor in the multiple risk environment, determine a value for one or more risk coefficient factors and opportunity coefficient factors, calculate a weighted average for risk coefficient factors based on each risk factor, an opportunity cost coefficient based on opportunity coefficient factors, and calculate the decision quantitatively based on the weighted average for risk coefficients and the opportunity cost coefficient.
